(19) United States
(12) Patent Application Publication
(10) Pub. No.: US 2023/0175657 A1
(43) Pub. Date: Jun. 8, 2023

(54) LAMP

(71) Applicant: Hangzhou Hangke Optoelectronics Co., Ltd., Hangzhou (CN)

(72) Inventors: Qianjun YAN, Hangzhou (CN); Zhaozhang ZHENG, Hangzhou (CN); Lingli MA, Hangzhou (CN)

(73) Assignee: Hangzhou Hangke Optoelectronics Co., Ltd., Hangzhou (CN)

(21) Appl. No.: 17/648,510

(22) Filed: Jan. 20, 2022

(30) Foreign Application Priority Data
Dec. 8, 2021 (CN) 202123076871.6

(51) Int. Cl. F21S 8/04; F21V 23/02; F21V 3/04; F21V 5/04; F21S 4/22; F21Y 115/10

(52) U.S. Cl. CPC F21S 8/04; F21S 4/22; F21V 3/04; F21V 5/04; F21V 23/023; F21Y 2115/10

(57) ABSTRACT

A lamp is provided in this disclosure, which includes a lamp body, a light-transmissive cover and a light-emitting strip. An inner wall of the lamp body is provided with a step layer, and the light-emitting strip is installed on the step layer. The step layer is composed of a plurality of annular steps, and the plurality of annular steps decrease in size successively. The light-emitting strip is fixed to a step of the step layer, and a light-emitting surface of the light-emitting strip is disposed towards the light-transmissive cover. A new downlight structure is provided in this disclosure.

### CROSS-REFERENCE TO RELATED APPLICATIONS

This Non-provisional application claims priority under 35 U.S.C. §119(a) to Chinese Patent Application No. 202123076871.6, filed on 08 Dec. 2021, the entire contents of which are hereby incorporated by reference in its entirety.

### TECHNICAL FIELD

The disclosure relates to a field of lighting, in particular to a lamp.

### BACKGROUND ART

In a light-down lighting fixture such as a downlight, a spotlight, etc., which is embedded in a ceiling, light is projected downwards, which belongs to direct light distribution. It functions well to decorate. However, it is of a single structure, and most of its internal light-emitting assemblies are of light board structures, with very little variability. In addition, it is concealedly installed and a casing assembly is not required in designing, which further results in singularity of such light.

In another type of lamp such as a desk lamp and a street lamp, a light-emitting assembly is mostly of a single- light bulb structure, which emits monotonous light.

### SUMMARY

In view of shortcomings in the prior art, a novel lamp with a light-emitting assembly provided on its inner wall is provided in this disclosure.

In order to solve the above technical problems, the present disclosure provides following technical solutions.

A lamp includes following components:
a lamp body, a light-transmissive cover and a light-emitting strip,
an inner wall of the lamp body is provided with a step layer, and the light-emitting strip is installed on the step layer.

Optionally, the step layer is composed of a plurality of annular steps, and the plurality of annular steps decrease in size successively.

Optionally, the step layer is a spiral step layer extending along the inner wall of the lamp body.

Optionally, a spiral diameter of each level of the spiral step layer decreases successively.

Optionally, the light-emitting strip is fixed to a step of the step layer, and a light-emitting surface of the light-emitting strip is disposed towards the light-transmissive cover.

Optionally, a bottom of the lamp body or a bottom of the step layer is provided with a light-emitting assembly.

Optionally, a lens structure is provided outside the light-emitting assembly.

Optionally, a lens structure is provided outside the light-emitting surface of the light-emitting strip.

Optionally, the light-transmissive cover includes a lens structure.

Optionally, the lamp is a downlight or a spotlight.

Optionally, a reflective layer is provided on a surface of the step layer and/or the bottom of the lamp body.

Optionally, the lamp body is further equipped with a power supply assembly.

The disclosure has advantages that:

In the disclosure, a lamp with the light-emitting strip and the light-emitting assembly which is different from the traditional one in terms of installing methods is provided, the light-emitting strip is arranged on the inner wall of the lamp body, thus realizing light effect different from the traditional downlight, and a more diversified light-emitting structure of the lamp body at the same time.

### BRIEF DESCRIPTION OF THE DRAWINGS

In order to explain the embodiments of the present disclosure or the technical scheme in the prior art more clearly, the drawings required in the description of the embodiments or the prior art will be briefly introduced below; obviously, the drawings in the following description are only some embodiments of the present disclosure, and other drawings can be obtained according to these drawings by those of ordinary skill in the art without paying creative labor.

FIG. 1 is a schematic diagram of a lamp disclosed in this application;

FIG. 2 is a schematic diagram of a lamp disclosed in Embodiment 3 of this application.

### DETAILED DESCRIPTION

The present disclosure will be further described in detail with reference to the following examples which are explanation of the present disclosure and the present disclosure is not limited to the following examples.

### Embodiment 1

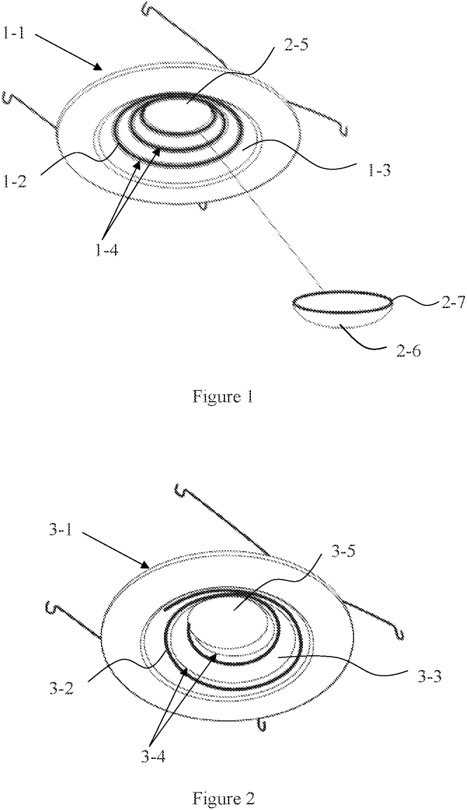

A lamp is disclosed in this embodiment, as shown in FIG. 1, which includes a lamp body 1-1, a light-transmissive cover and a light-emitting strip 1-2. The lamp body is equipped with a power supply assembly. An inner wall 1-3 of the lamp body is provided with a step layer, and the light-emitting strip is installed on the step layer.

Specifically, the step layer is composed of a plurality of annular steps 1-4, and the plurality of annular steps decrease in size successively. In an implementation, the step layer is composed of a plurality of concentric rings, and the plurality of concentric rings decrease in size successively. The concentric rings are hollow, and the plurality of concentric rings form a tower-shaped hollow cavity. It can be understood that a smallest concentric ring is far away from a light-transmitting lampshade.

Each concentric ring includes an annular step, that is to say, the annular step can be understood as a platform provided on the inner wall of the lamp body and surrounding the inner wall of the lamp body. The light-emitting strip is fixed to a step of the step layer, and a light-emitting surface of the light-emitting strip is disposed towards the light-transmissive cover.

The lamp disclosed in this embodiment is a downlight, a spotlight or a desk lamp in which an inner wall or side wall of a lamp body can be provided with the step layer, and other lamps are not excluded.

It can be contemplated that the concentric ring can be a geometric concentric ring, a petal-shaped ring, etc.

In an implementation, the step layer is composed of annular step levels axially staggered.

Further, in order to achieve other different light effect, a reflective layer is provided on a surface of the step layer.

### Embodiment 2

A lamp is disclose in this embodiment, its components are substantially the same as those in Embodiment 1, so reference is still made to FIG. 1. This scheme is based on that of Embodiment 1 described above. Further, a bottom 2-5 of the lamp body or a bottom of the step layer is provided with a light-emitting assembly.

Specifically, a bottom of the lamp (a bottom surface, that is, a side away from a lampshade) is of a planar structure, and the light-emitting component is provided on this bottom, which can be a group of LED arrays outside of which is provided with a lens structure 2-7, and a bottom of the lens structure is provided with a circle of light strips 2-7 matched with it.

There are other alternative structures as follows: the bottom of the lamp body is provided with an annular structure composed of light strips, which can be regarded as a last step level structure, and the lens structure is provided outside the annular structure.

In another implementation, the lens structure is provided outside the light-emitting surface of the light-emitting strip, and a LED light source on the light-emitting strip is focused by the lens structure.

In another implementation, the light-transmissive cover includes a lens structure, and whole light emitted by the light-emitting strip installed on the step layer is focused by the lens structure.

In another implementation, in order to achieve another light effect, the bottom of the lamp body is provided with a reflective layer, while the surface of the step layer is provided with a reflective layer.

### Embodiment 3

A lamp is disclosed in this embodiment, which includes a lamp body 3-1, a light-transmissive cover and a light-emitting strip 3-2. The lamp body is equipped with a power supply assembly. An inner wall 3-3 of the lamp body is provided with a step layer, and the light-emitting strip is installed on the step layer.

The step layer is a spiral step layer 3-4 extending along the inner wall of the lamp body. A spiral diameter of each level of the spiral step layer decreases successively.

The light-emitting strip is fixed to a step of the step layer, and a light-emitting surface of the light-emitting strip is disposed towards the light-transmissive cover.

Specifically, a bottom 3-5 of the lamp (a bottom surface, that is, a side away from a lampshade) is of a planar structure, and the light-emitting component is provided on this bottom, which can be a group of LED arrays outside of which is provided with a lens structure.

There is another alternative structure as follows: a level of the spiral step layer with a smallest diameter is arranged at the bottom of the lamp, and the lens structure is covered on this level.

In another implementation, the lens structure is provided outside the light-emitting surface of the light-emitting strip, and a LED light source on the light-emitting strip is focused by the lens structure.

In another implementation, the light-transmissive cover includes a lens structure, and whole light emitted by the light-emitting strip installed on the step layer is focused by the lens structure.

In addition, it should be noted that the specific embodiments described in this specification may have different shapes, names or the like of parts and components. Equivalent or simple changes made in accordance with the configurations, features and principles described in the inventive concept are included in the scope of protection of the disclosure. Various modifications, supplements or similar replacements can be made to the described specific embodiments by those skilled in the art to which the present disclosure pertains, which fall within the protection scope of the present disclosure without departing from the structure of the present disclosure or beyond the scope defined by the claims.

What is claimed is:

1. A lamp, comprising:
a lamp body, a light-transmissive cover and a light-emitting strip, wherein
an inner wall of the lamp body is provided with a step layer, and the light-emitting strip is installed on the step layer.

2. The lamp according to claim 1, wherein the step layer is composed of a plurality of annular steps, and the plurality of annular steps decrease in size successively.

3. The lamp according to claim 1, wherein the step layer is a spiral step layer extending along the inner wall of the lamp body.

4. The lamp according to claim 3, wherein a spiral diameter of each level of the spiral step layer decreases successively.

5. The lamp according to claims 1, wherein the light-emitting strip is fixed to a step of the step layer, and a light-emitting surface of the light-emitting strip is disposed towards the light-transmissive cover.

6. The lamp according to claims 2, wherein the light-emitting strip is fixed to a step of the step layer, and a light-emitting surface of the light-emitting strip is disposed towards the light-transmissive cover.

7. The lamp according to claims 3, wherein the light-emitting strip is fixed to a step of the step layer, and a light-emitting surface of the light-emitting strip is disposed towards the light-transmissive cover.

8. The lamp according to claims 4, wherein the light-emitting strip is fixed to a step of the step layer, and a light-emitting surface of the light-emitting strip is disposed towards the light-transmissive cover.

9. The lamp according to claim 1, wherein a bottom of the lamp body or a bottom of the step layer is provided with a light-emitting assembly.

10. The lamp according to claim 9, wherein a lens structure is provided outside the light-emitting assembly.

11. The lamp according to claim 1, wherein a lens structure is provided outside the light-emitting surface of the light-emitting strip.

12. The lamp according to claim 1, wherein the light-transmissive cover comprises a lens structure.

13. The lamp according to claim 1, wherein the lamp is a downlight or a spotlight.

14. The lamp according to claim 9, wherein a reflective layer is provided on a surface of the step layer and/or the bottom of the lamp body.

15. The lamp according to claim 1, wherein the lamp body is further equipped with a power supply assembly.
